(19) United States
(12) Patent Application Publication
(10) Pub. No.: US 2008/0273189 A1
(43) Pub. Date: Nov. 6, 2008

(54) Sheet Body Holding Mechanism and Lithography Apparatus Using Same

(75) Inventor: Kazuhiro Terada, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku, Tokyo (JP)

(21) Appl. No.: 11/885,587

(22) PCT Filed: Feb. 7, 2006
(86) PCT No.: PCT/JP2006/302090

§ 371 Date: Sep. 4, 2007

(30) Foreign Application Priority Data
Mar. 3, 2005 (JP) 2005-059190

(51) Int. Cl. G03B 27/60

(52) U.S. Cl. 355/73

(57) ABSTRACT

Highly accurate lithography is performed by maintaining planarity without generating a suction mark on a sheet body. Since a counterbore for storing the head of a screw member for fixing a suction plate on a supporting table communicates with the atmosphere through a long hole and communicating path, inside of the counterbore is never under a negative pressure at the time of sucking the sheet body through a hole section of the suction plate, and the substrate can be held by suction on the suction plate by highly accurately maintaining planarity.

### TECHNICAL FIELD

The present invention relates to a sheet body holding mechanism for attracting and holding a sheet body, and an image recording apparatus (a lithography apparatus) having such a sheet body holding mechanism.

### BACKGROUND ART

There has been developed an exposure apparatus for controlling a laser beam according to a desired image pattern to expose and scan a sheet body made of a photosensitive material with the laser beam for thereby manufacturing filters for liquid crystal displays, plasma displays, etc. and multilayer printed wiring boards (see Japanese Laid-Open Patent Publication No. 2004-62155).

In the above exposure apparatus, it is necessary for the sheet body to be positioned and held highly accurately by an exposure stage in order to record an image in a predetermined position on the sheet body. Particularly, if certain patterns need to be exposed and recorded in an overlapping manner in the given position on the same sheet body while the sheet body is repeatedly mounted and removed for producing color filters for color liquid crystal displays and multilayer printed wiring boards, then it is extremely important to keep the positioning accuracy for the sheet body to avoid positional misalignments between the patterns.

A sheet holding mechanism shown in FIG. 8, for example, is employed as a mechanism for positioning and holding a sheet body. The sheet holding mechanism comprises a suction plate 4 having a number of air suction holes 2 defined therein and fixedly mounted on a support base 8 by a screw 6. After a sheet body 1 is placed on the suction plate 4, air is drawn from the air suction holes 2 to attract and hold the sheet body 1 on the suction plate 4.

### DISCLOSURE OF THE INVENTION

The suction plate 4 has a counterbore 3 defined in a portion where the screw 6 is threaded in, for making the sheet body 1 that is attracted to the suction plate 4 flat. When air is drawn from the air suction holes 2 to attract the sheet body 1, air in the counterbore 3 is also drawn. If the sheet body 1 is thin and the counterbore 3 is large, then the area of the sheet body 1 over the counterbore 3 is deformed, developing a suction mark or displacing an exposure position in the thickness direction of the sheet body 1, so that the image on the sheet body 1 may possibly be blurred.

It is a general object of the present invention to provide a sheet body holding mechanism which is capable of keeping a sheet body flat for highly accurate image-recording without developing a suction mark on the sheet body, and an image recording apparatus having such a sheet body holding mechanism.

### BRIEF DESCRIPTION OF THE DRAWINGS

FIG. 1 is an external perspective view of an exposure apparatus according to an embodiment of the present invention;

FIG. 2 is a schematic view of an exposure head of the exposure apparatus according to the embodiment;

FIG. 3 is an exploded view of an exposure stage of the exposure apparatus according to the embodiment;

FIG. 4 is a view of a connection structure which interconnects a support base and a suction plate of the exposure stage of the exposure apparatus according to the embodiment;

FIG. 5 is a view of an air intake/discharge structure of the exposure stage of the exposure apparatus according to the embodiment;

FIG. 6 is a view of a connection structure according to another embodiment which interconnects the support base and the suction plate of the exposure stage of the exposure apparatus according to the embodiment;

FIG. 7 is a view of a connection structure according to still another embodiment which interconnects the support base and the suction plate of the exposure stage of the exposure apparatus according to the embodiment; and

FIG. 8 is a view of a connection structure which interconnects a support base and a suction plate according to conventional art.

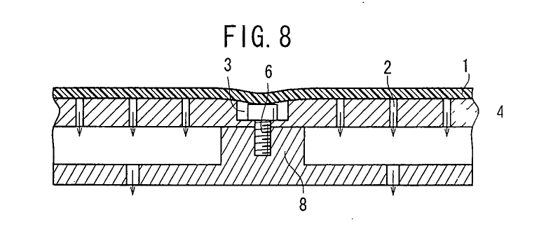

### BEST MODE FOR CARRYING OUT THE INVENTION

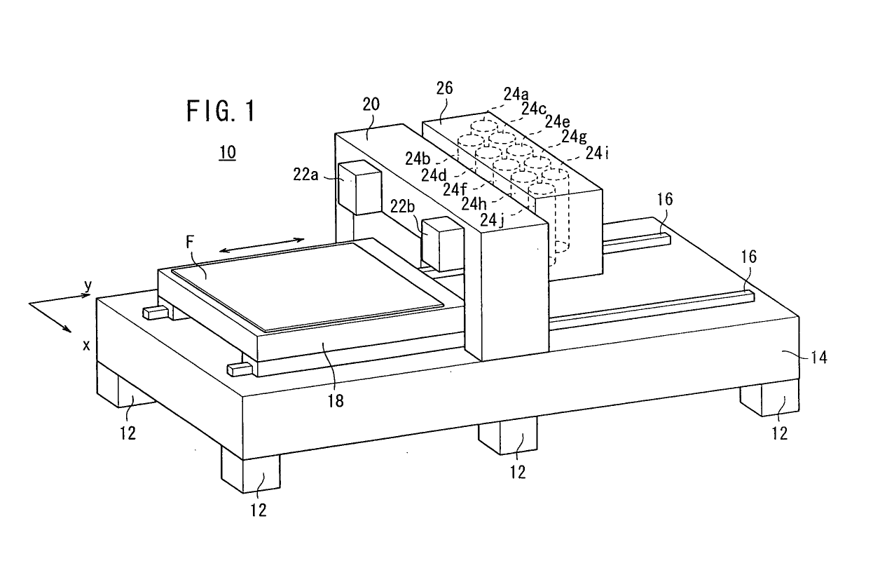

FIG. 1 shows an exposure apparatus 10 for performing an exposure process on a printed wiring board or the like, which is an image recording apparatus according to an embodiment of the present invention. The exposure apparatus 10 has a bed 14, which has extremely small deformations, supported by a plurality of legs 12, and an exposure stage 18 (working stage) mounted on the bed 14 by two guide rails 16 for reciprocating movement in the directions indicated by the arrow. A rectangular substrate F (sheet body) coated with a photosensitive material is attracted to and held on the exposure stage 18.

A portal column 20 is mounted centrally on the bed 14 over the guide rails 16. Cameras 22a, 22b are fixed to one side of the column 20 for detecting an alignment mark recorded on the substrate F. A scanner 26 having a plurality of exposure heads 24a through 24j positioned and held therein for recording an image on the substrate F by way of exposure is fixed to the other side of the column 20. The exposure heads 24a through 24j are arranged in two staggered rows in a direction perpendicular to the directions in which the substrate F is scanned (the directions in which the exposure stage 18 is movable).

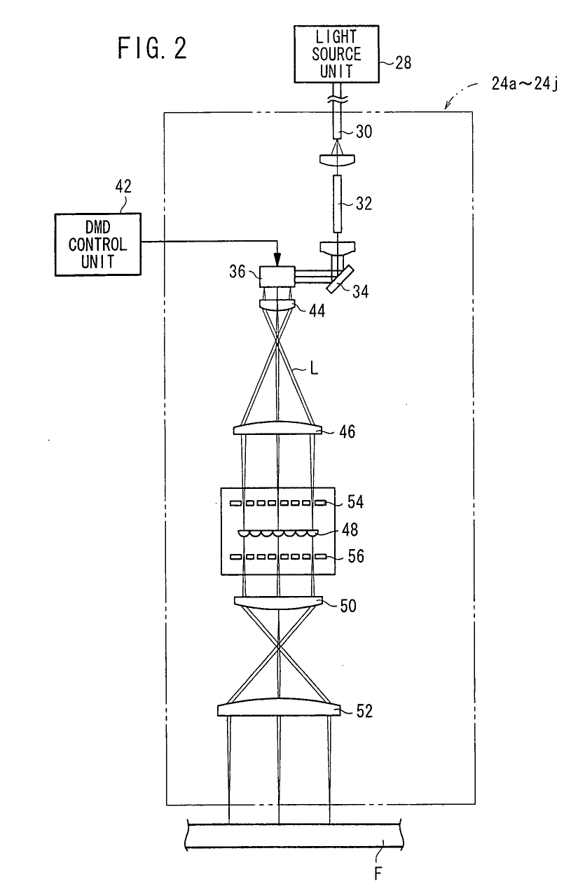

FIG. 2 shows a structure of each of the exposure heads 24a through 24j. For example, a combined laser beam L emitted from a plurality of semiconductor lasers of a light source unit 28 is introduced through an optical fiber 30 into each of the exposure heads 24a through 24j. A rod lens 32, a reflecting mirror 34, and a digital micromirror device (DMD) 36 are successively arranged on an exit end of the optical fiber 30 into which the laser beam L is introduced.

The DMD 36 comprises a number of micromirrors that are swingably disposed in a matrix pattern on SRAM cells (memory cells). A material having a high reflectance such as aluminum or the like is evaporated on the surface of each of the micromirrors. When a digital signal according to image recording data is written in the SRAM cells by a DMD control unit 42, the micromirrors are tilted in given directions depending on the applied digital signal. Depending on how the micromirrors are tilted, the laser beam L is turned on or off.

In the direction in which the laser beam L reflected by the DMD 36 that is controlled to be turned on or off is emitted, there are successively disposed first image focusing optical lenses 44, 46 of a magnifying optical system, a microlens array 48 having many lenses corresponding to the respective micromirrors of the DMD 36, and second image focusing optical lenses 50, 52 of a zooming optical system. Microaperture arrays 54, 56 for removing stray light and adjusting the laser beam L to a predetermined diameter are disposed in front of and behind the microlens array 48.

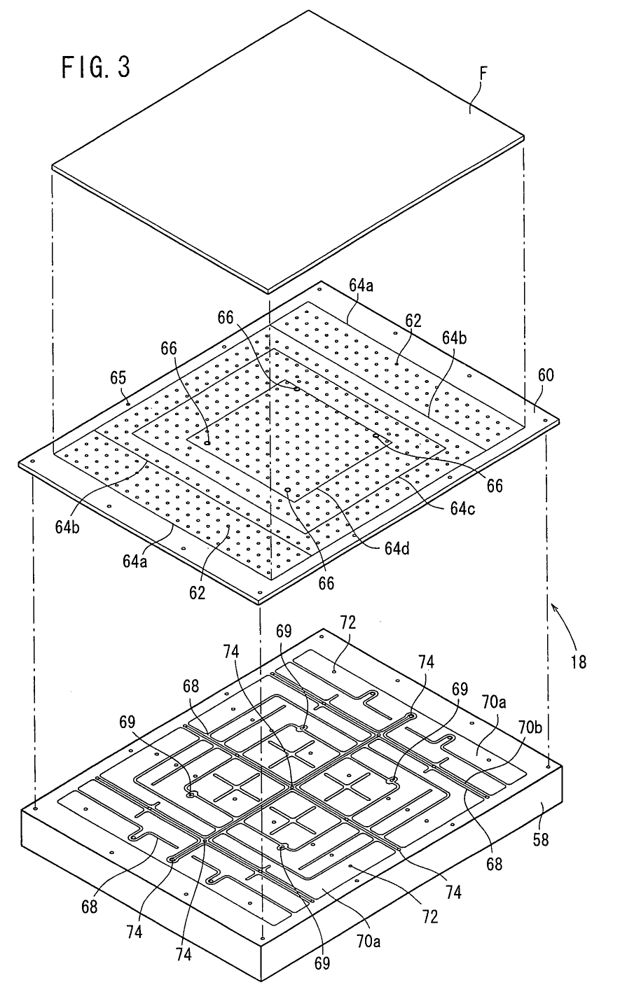

FIG. 3 is a view of the exposure stage 18 for positioning and holding the substrate F. The exposure stage 18 comprises a support base 58 movable along the guide rails 16 and a suction plate 60 fastened to the support base 58 by screws for attracting and holding the substrate F.

The suction plate 60 has a number of holes 62 defined in a suction surface thereof and arranged in a matrix, and also has suction grooves 64a through 64d defined in the suction surface and depending on the sizes of substrates F that can be attracted to and held by the suction plate 60. Screw holes 65, 66 are defined in regions of the suction plate 60 near the peripheral edges and the suction groove 64d for receiving screws which fasten the suction plate 60 to the support base 58.

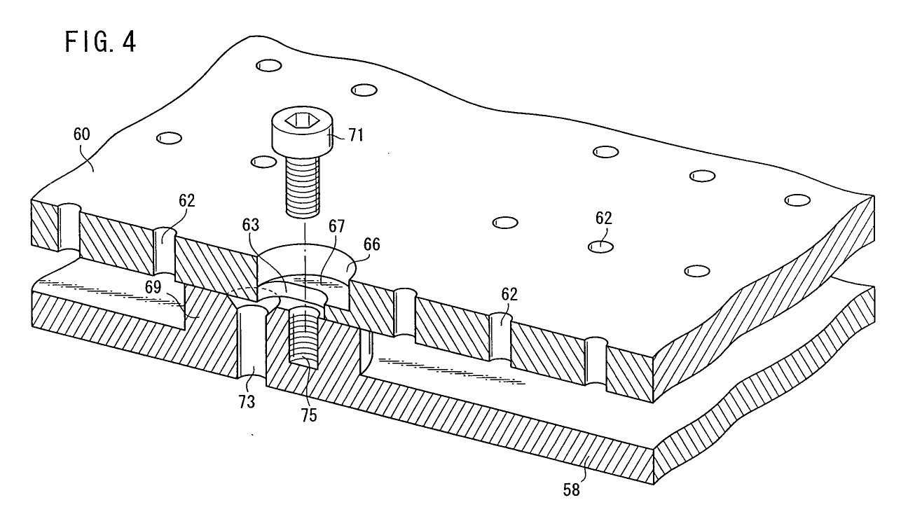

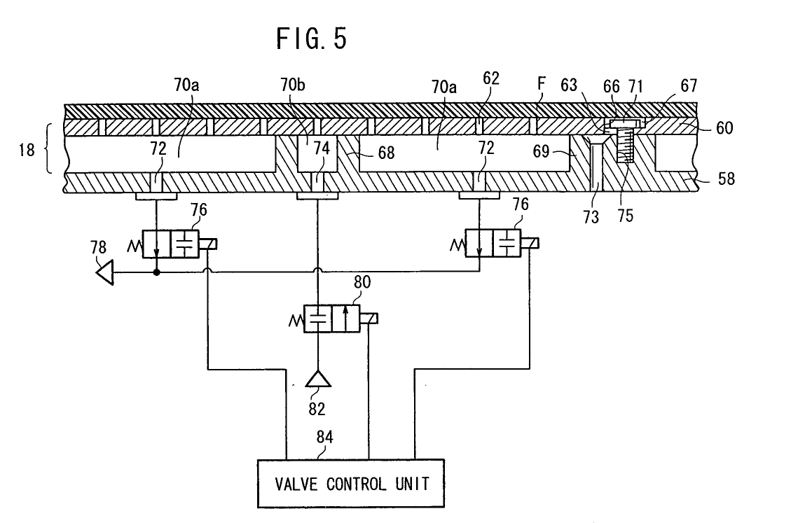

As shown in FIGS. 4 and 5, a counterbore 67 is defined around each of the screw holes 66 that are positioned in an area wherein the substrate F is placed. The counterbore 67 receives the head of a screw 71 to prevent the head from projecting from the suction surface of the suction plate 60. An oblong hole 63 is defined in the bottom of the counterbore 67 for receiving the threaded shank of the screw 71 loosely therein. The oblong hole 63 extends from the suction surface to the reverse side of the suction plate 60.

The support base 58 has recesses 70a, 70b divided into a plurality of regions by convex partitions 68 so as to substantially correspond to the sizes of the substrates F that can be attracted to and held in position by the suction plate 60. Air suction holes 72 which are held in communication with the holes 62 defined in the suction plate 60 are defined in the recesses 70a. Air discharge holes 74 which are held in communication with the holes 62 defined in the suction plate 60 are defined in a central region of the support base 58 and the recesses 70b between the partitions 68 disposed in regions corresponding to positions substantially along the suction grooves 64b defined in the suction plate 60. Bosses 69 wherein threaded holes 75 for threading the screws 71 therein and communication passages 73 communicating with the oblong holes 63 in the screw holes 66 are defined are disposed in regions corresponding to the screw holes 66 defined in the suction plate 60.

FIG. 5 shows in fragmentary cross section the exposure stage 18 on which the substrate F is mounted. The air suction holes 72 defined in the recesses 70a and the air discharge holes 74 defined in the recesses 70b are isolated from each other by the partitions 68. A vacuum suction source 78 is connected through solenoid-operated valves 76 to the air suction holes 72. A compressed air supply source 82 is connected through solenoid-operated valves 80 to the air discharge holes 74. The solenoid-operated valves 76, 80 are controlled by a valve control unit 84. The communication passages 73 defined in the bosses 69 are vented to the atmosphere.

The exposure apparatus 10 according to the present embodiment is basically constructed as described above. Operation of the exposure apparatus 10 will be described below.

First, a process of attracting and holding the substrate F on the exposure stage 18 will be described below.

The valve control unit 84 turns off the solenoid-operated valves 76 communicating with the air suction holes 72 in the support base 58, and turns on the solenoid-operated valves 80 communicating with the air discharge holes 74 in the support base 58. The compressed air supply source 82 supplies compressed air through the solenoid-operated valves 80 to the air discharge holes 74. The compressed air supplied to the air discharge holes 74 is discharged upwardly from the holes 62 in the suction plate 60. In this state, the substrate F is placed by using unillustrated positioning member, which is disposed on the suction plate 60, as a reference point. The amount of compressed air discharged from the holes 62 should preferably be set to a level not large enough to cause the placed substrate F from floating off. The supply of the compressed air reduces frictional forces between the suction plate 60 and the substrate F. As the substrate F not attracted to the suction plate 60, the substrate F will be prevented from being kept in sliding contact with the suction plate 60 and from damaging its reverse side when the substrate F is to be positioned.

After it is confirmed that the substrate F is placed in a given position on the suction plate 60, the valve control unit 84 turns off the solenoid-operated valves 80 communicating with the air discharge holes 74 and turns on the solenoid-operated valves 76 communicating with the air suction holes 72. The vacuum suction source 78 then draws air from the air suction holes 72. The substrate F is attracted and held in the given position on the suction plate 60 by the air drawn from the holes 62.

The counterbores 67 which accommodate therein the heads of the screws 71 that secure the suction plate 60 to the support base 58 are communicated with the atmosphere through the oblong holes 63 and the communication passages 73. Even when air is drawn from the counterbores 67 through the holes 62, no negative pressure is developed in the counterbores 67. Therefore, the substrate F is free from suction marks which would otherwise be produced if the substrate F is deformed, and is kept flat highly accurately. Since the substrate F is not sucked into the counterbores 67, the counterbores 67 do not need to be filled with a filler, and hence the exposure stage 18 can efficiently be serviced for maintenance or the like.

If mount holes for a positioning member, not shown, for positioning the substrate F on the suction plate 60 are defined in the suction plate 60, then communication passages 73 may also be defined in such mount holes.

After the substrate F has thus been positioned and held on the exposure stage 18, an exposure process is started.

The exposure stage 18 moves in one direction along the guide rails 16 on the bad 14. When the exposure stage 18 moves between the posts of the column 20, the cameras 22a, 22b read the alignment mark recorded in a given position on the substrate F. The positional data of the read alignment mark is used as position correcting data of the substrate F.

After the position correcting data has been calculated, the exposure stage 18 moves in the opposite direction, and the scanner 26 starts recording an image on the substrate F by way of exposure.

Specifically, the laser beam L emitted from the light source unit 28 is introduced through the optical fiber 30 into the exposure heads 24a through 24f. The introduced laser beam L travels through the rod lens 32 and is applied from the reflecting mirror 34 to the DMD 36.

Image recording data is corrected by the position correcting data and supplied to the DMD 36, turning on and off the micromirrors thereof. The laser beam L that is selectively reflected in a desired direction by each of the micromirrors of the DMD 36, is magnified by the first image focusing optical lenses 44, 46, adjusted to a predetermined diameter by the microaperture array 54, the microlens array 48, and the microaperture array 56, then adjusted to a predetermined magnification by the second image focusing optical lenses 50, 52, and led to the substrate F. The exposure stage 18 moves along the bed 14, while a desired two-dimensional image is recorded on the substrate F by the exposure heads 24a through 24j that are arrayed in the direction perpendicular to the moving direction of the exposure stage 18.

When the exposure recording process is finished, the substrate F is removed from the exposure stage 18. Specifically, the valve control unit 84 turns off the solenoid-operated valves 76 communicating with the air suction holes 72 in the support base 58, and turns on the solenoid-operated valves 80 communicating with the air discharge holes 74 in the support base 58. The compressed air supply source 82 supplies compressed air through the solenoid-operated valves 80 to the air discharge holes 74. The compressed air supplied to the air discharge holes 74 is supplied to the reverse side of the substrate F from the holes 62 in the substrate F. As a result, the substrate F which has been attracted to and held by the suction plate 60 is released, and can easily be separated from the suction plate 60.

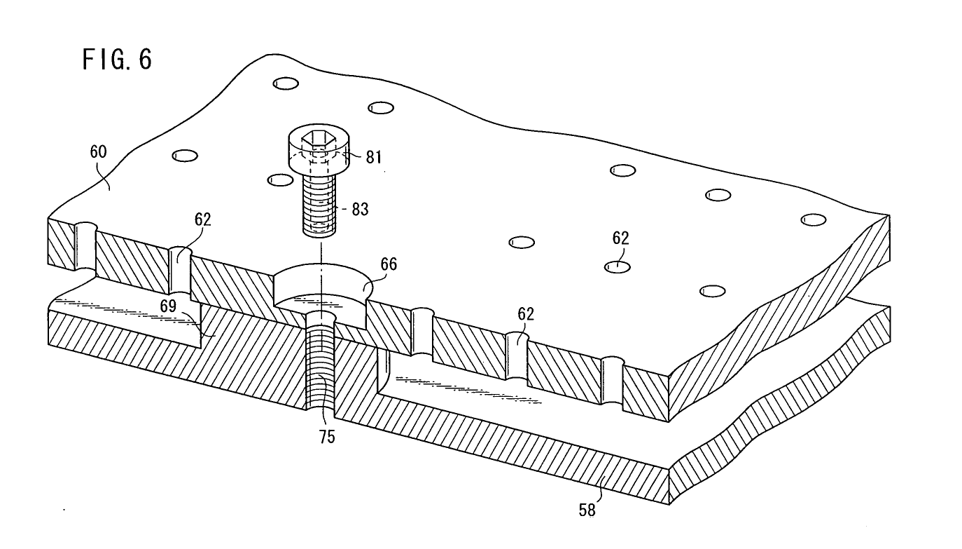

In the above embodiment, the oblong holes 63 and the communication passages 73 that are communicated with the atmosphere are defined in the suction plate 60 and the support base 58. As shown in FIG. 6, the threaded hole 75 defined in the boss 69 of the support base 58 may be constructed as a through hole, and a through hole 83 may be defined in a screw 81 threaded into the threaded hole 75, so that the suction surface of the suction plate 60 may be communicated with the atmosphere through the through hole 83 and the threaded hole 75.

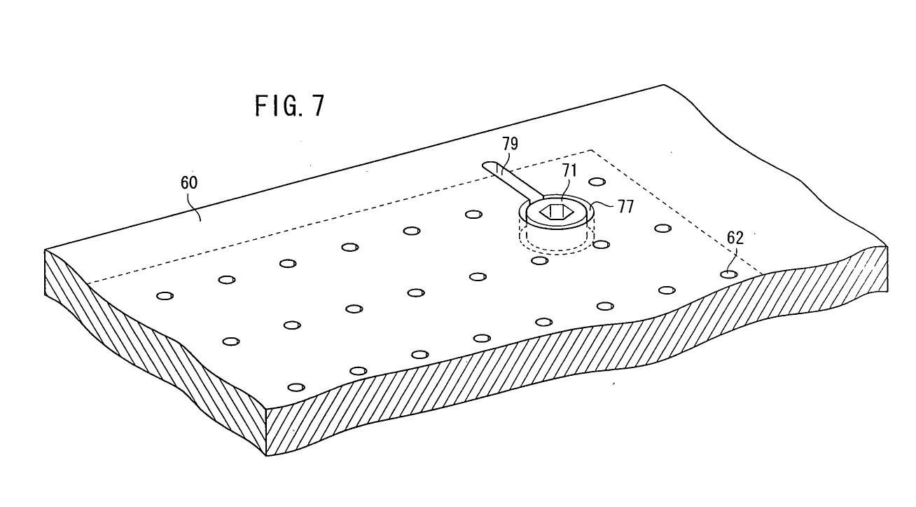

Alternatively, as shown in FIG. 7, a groove 79 may have an end communicating with a counterbore 77 which receives therein the head of a screw 71 that secures the suction plate 60 to the support base 58, and may have the other end extending over the outermost suction groove 64a for the substrate F. When the substrate F is attracted to the suction plate 60, since the counterbore 77 is communicated with the atmosphere through the groove 79, the substrate F is not sucked into the counterbore 77, and is kept flat highly accurately.

The exposure apparatus 10 may appropriately be used to expose a dry film resist (DFR) in a process of manufacturing a printed wiring board (PWB), to form a color filter in a process of manufacturing a liquid crystal display (LCD), to expose a DFR in a process of manufacturing a TFT, and to expose a DFR in a process of manufacturing a plasma display panel (PDP), etc., for example. The present invention is not limited to an exposure apparatus, but may be applied to an image recording apparatus having an ink jet recording head.

1. A sheet body holding mechanism for attracting and holding a sheet body, comprising:
a suction plate including a number of air suction holes defined in a flat suction surface thereof, for attracting and holding said sheet body on said suction surface with an air suction through said air suction holes;
a support base supporting said suction plate thereon and securing said suction plate with a fastening member inserted through a mounting hole defined in said suction surface; and
a communication passage venting said mounting hole of said suction plate to the atmosphere with said sheet body being attracted to and held by said suction plate.

2. A sheet body holding mechanism according to claim 1, wherein said communication passage comprises a through hole defined in said mounting hole and extending from said suction surface to a reverse side of said suction plate.

3. A sheet body holding mechanism according to claim 2, wherein said through hole comprises an oblong hole defined in a counterbore in which said fastening member is inserted.

4. A sheet body holding mechanism according to claim 1, wherein said communication passage comprises a through hole defined in said fastening member and extending from said suction surface to a reverse side of said suction plate.

5. A sheet body holding mechanism according to claim 1, wherein said communication passage comprises a groove extending from said mounting hole along said suction surface of said suction plate over an outer peripheral edge of said sheet attracted to and held by said suction plate so as to communicated with the atmosphere.

6. A sheet body holding mechanism according to claim 1, wherein said support base includes an atmospheric communication passage venting said mounting hole to the atmosphere and an air suction means communication passage providing communication between said air suction holes and air suction means.

7. A sheet body holding mechanism for attracting and holding a sheet body, comprising:
a suction plate including a number of air suction holes defined in a flat suction surface thereof, for attracting and holding said sheet body on said suction surface with an air suction through said air suction holes;
a mounting hole mounting a predetermined member on said suction plate; and
a communication passage venting said mounting hole of said suction plate to the atmosphere with said sheet body being attracted to and held by said suction plate.

8. A sheet body holding mechanism according to claim 7, wherein said communication passage comprises a groove extending from said mounting hole along said suction surface of said suction plate over an outer peripheral edge of said sheet attracted to and held by said suction plate so as to communicated with the atmosphere.

9. An image recording apparatus for recording an image on a sheet body attracted and held in a predetermined position on a working stage, said working stage comprising:
a suction plate including a number of air suction holes defined in a flat suction surface thereof, for attracting and holding said sheet body on said suction surface with an air suction through said air suction holes;
a support base supporting said suction plate thereon and securing said suction plate with a fastening member inserted through a mounting hole defined in said suction surface; and
a communication passage venting said mounting hole of said suction plate to the atmosphere with said sheet body being attracted to and held by said suction plate.

10. An image recording apparatus according to claim 9, wherein said stage is movable in one direction while said sheet body is being attracted to and held by said suction plate, said image recording apparatus comprising an image recording head for scanning said sheet body in a direction perpendicular to said one direction to record an image on said sheet body.
